(19) United States
(12) Patent Application Publication
(10) Pub. No.: US 2006/0262990 A1
(43) Pub. Date: Nov. 23, 2006

(54) Dual-mode high throughput de-blocking filter

(75) Inventors: Chen-Yi Lee, Hsinchu City (TW); Tsu-Ming Liu, Hsinchu City (TW)

Correspondence Address: BUCKNAM AND ARCHER, 1077 NORTHERN BOULEVARD, ROSLYN, NY, 11576, US

(73) Assignee: National Chiao-Tung University, Hsinchu City (TW)

(21) Appl. No.: 11/205,811

(22) Filed: Aug. 17, 2005

(30) Foreign Application Priority Data
May 20, 2005 (TW) 094116487

(51) Int. Cl. G06K 9/40; G06K 9/36

(52) U.S. Cl. 382/268; 382/232

(57) ABSTRACT

This invention provides the unique and high-throughput architecture for multiple video standards. Particularly, we propose a novel scheme to integrate the standard in-loop filter and the informative post-loop filter. Due to the non-standardization of post filter, it provides high freedom to develop a certain suitable algorithm for the integration with loop-filter. We modify the post filter algorithm to make a compromise between hardware integration complexity and performance loss. Further, we propose a hybrid scheduling to reduce the processing cycles and improve the system throughput. The main idea is that we use four pixel buffers to keep the intermediate pixel value and perform the horizontal and vertical filtering process in one hybrid scheduling flow. In our approach, we reduce processing cycles, and the synthesized gate counts are very small. Meanwhile, the synthesized results also indicate lower cost for hardware.

### FIELD OF THE INVENTION

The invention generally relates to a video filter and its scheduling method; more specifically, to a dual-mode high throughput de-blocking filter and its scheduling method.

### BACKGROUND OF THE INVENTION

Recently, various video coding standards are widely in use. Traditional MPEG standards support the features of backward compatibility. However, H. 364/AVC is the newest video standard, which is different from the conventional H-263 or MPEG-4, and there is no backward compatibility of these former video coding standards. Therefore, the development of combined video coding standard is a must to meet the different system requirements. Both H.264/AVC and MPEG-4 adopt the de-blocking filter to eliminate the blocking artifacts, however, the H.264/AVC adopts the de-blocking filter as an in-loop process and the other standards adopt it as a post-loop process. In traditional de-blocking architecture, vertical edges are filtered first, and then horizontal edges are filtered. Unfiltered pixel data should be fetched in each direction. Therefore, memory accesses are double for one 4×4 sub-block or 8×8 block boundaries.

Moreover, H.264/AVC has achieved significant rate-distortion efficiency by many useful tools, De-blocking filter placed in the prediction place is one important tool to increase the coding efficiency and remove the blocking artifacts. Generally, the de-blocking filter contributes about one-third of the computational complexity of the decoder, and it's the system bottleneck in terms of processing cycles (see FIG. 9). Compared to the loop filters in H.263 or MPEG-4/H.263 post filters, the de-blocking filter in H.264 operates each filter process on 4×4 sub-block structure instead of 8×8 block structure. Thus, a large amount of computation and memory access are its penalty for the real-time decoding demand.

In known technologies, U.S. Pat. No. 6,081,552 entitle “Video coding using a maximum a posteriori loop filter” has proposed a video filter, however, the proposed filter is simply an improvement for a loop filter; and U.S. Pat. No. 5,819,035 entitled “Poster-filter for removing ringing artifacts of DCT coding” is just a study for post-filter. Further, U.S. Pat. No. 6,717,613 entitled “Block deformation removing filter” has disclosed a filter for being capable of application on both loop filter and post filter, however, the efficiency is hard to achieve an optimum effect.

In known documentation, Yu-Wen Huang, To-Wei Chen, Bing-Yu Hsieh, Tu-Chih Wang, Te-Hao Chang and Liang-Gee Chen, “Architecture Design for Deblocking Filter in H.264/JVT/AVC” International Conference on Multimedia and Expo (ICME103), Vol. 1. pp. I-693-6, July 2003; and Miao Sima, Yuanhua Zhou and Wei Zhang, “an Efficient Architecture for Adaptive Deblocking Filter of H.264/AVC Video Coding” IEEE Transactions on Consumer Electronics, Vol. 50, Issue 1, pp. 292-296, February 2004, has studied in this field of technique, however, there is no any satisfactory solution to be proposed; Therefore, the shortcomings of the conventional technology can be concluded as the following:

A. The solution of current study is simply directed to the loop filter or post filter respectively. There is no any complete solution for integration of the future developed video standards, such as each series of H.26X and MPEG-X, and no any solution on the loop filter of H.264 and the post filter of H.263 and MPEG-4 which have substantial difference.

B. Though the current de-blocking hardware architecture is capable of facilitating the complicated filtering algorithm, however, it is still insufficient for decoding a high quality picture of video image. The reason is because there exists difficulty on memory access and arrangement of the ordering of the filter.

### SUMMARY OF THE INVENTION

Therefore, for solving the above problem, the invention provides a 8×8 post filter algorithm based on original 4×4 in-loop filter algorithm, and modifies filter ordering and numbers of edge pixels relevant to the filtering. Thus, by using such a method, the modified post filter can be easily integrated with the current 4×4 in-loop filter.

Instead of conventional LOP arrangement rule, the invention determines and provides a CoP data arrangement by using ordering of block decoding which is defined by the standard. Through this arrangement, correlation of edge data of intra prediction and inter prediction can be repeatedly utilized for improving overall system performance. Further, the invention retains the inherent features of original loop filter and post filter and employs a dual mode architecture to allow these filters to be closely connected, so as to achieve and optimum filtering performance by using a slightly increasing cost for hardware. Moreover, the invention provides combination of horizontal and vertical filtering to reduce memory access to external memory without modification of data dependency, so as to achieve a high throughput filtering architecture.

In concrete, the present invention modifies the original post filter unit of MPEG-4 base on the original H.264 loop filter algorithm to lower the physical loading for system integration and obtain the advantages of a dual mode of loop/post filtering.

For the filter unit and ordering defined in H.264, the invention provides a hybrid filter ordering wherein the minimum memory access number and minimum additional area can be achieved without modification of original data correlation.

### BRIEF DESCRIPTION OF THE DRAWINGS

Table 1 is an analysis of average memory access per luma MB;

Table 2 is a cycle analysis in the de-blocking filter unit;

Table 3 is parameter selection of the loop/post de-blocking filter;

Table 4 is features of the de-blocking filter in different standard;

Table 5 is the different data arrangement in the de-blocking filter;

FIG. 1 is the different data arrangement in the de-blocking filter (a) and prediction unit (b);

FIG. 2 is the slice memory with grid or shaded region and the content memory with black-dotted region;

FIG. 3 is the pixel-in-pixel-out filtering process with weak strength of the proposed loop/post filter;

FIG. 4 is the hybrid scheduling method according to the invention;

FIG. 5 is the partitioned MB and each time instance when applying the hybrid scheduling method;

FIG. 6 is the block diagram and data flow of the invention;

FIG. 7 is the detailed architecture for the de-blocking filter;

FIG. 8 is an overall cycle profiling of H.264/AVC through the HDL simulation; and

FIG. 9 is a performance comparison due to the modification of post filter.

### DRTAILED DESCRIPTION OF THE INVENTION

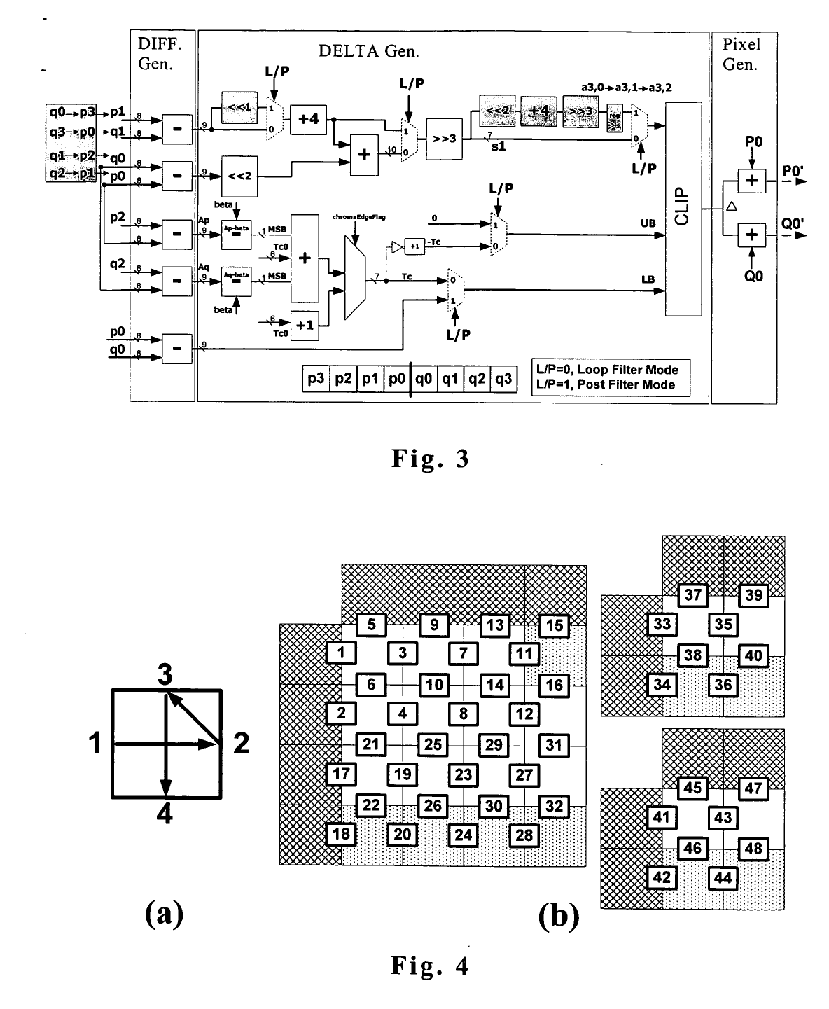

The object of the invention is to reduce the cost overhead of de-blocking filter for multiple standards and thus to develop a hybrid algorithm and an unique architecture of de-blocking filter. The video standards of H.264/VAC and the former MPEG adopt de-blocking filter as in-loop (i.e. loop) and post-loop filters, respectively. However, the performance of the improvement is very mild when applying the loop filter as the post filter in MPEG-4. Therefore, the present invention provides a hybrid algorithm to make a compromise between the integration cost and the performance loss. FIG. 3 shows the decision of the loop/post filter as provided. The hybrid algorithm retains the original loop filter due to the standardization in H.264/AVC. In addition, the present invention provides the modification of the post filter to facilitate an integration into original loop filter design and to lower the physical loading of the integration.

The algorithm according to the invention exploits the inherent features of loop and post filters. It can be partitioned into three main parts as identified in Table 3. In the filtered control, the present invention retains the filtered edge of 4×4 and 8×8 respectively. The reason is that the basic transformation unit that is located on the 4×4 sub-block and 8×8 block. Further, the present invention modifies the filtered ordering in post filter to unify into a hybrid structure. The filtered controls will be described in detail later. The following is an introduction of the algorithm of loop/post filter in terms of mode decision and filtering mode.

[Mode Decision]

There are several differences between the mode decision of loop and post filter. The loop filter is performed in the DPCM loop and controlled by the syntax parser. However, the post filter is applied after the video decoder and can be considered as a post-processing unit. The post filter is controlled by the neighboring pixels. To merge the mode decision, the present invention retains the mode decision features of loop and post filter. Further, the present invention modifies the mode decision of the post filter into the 8-pixel related algorithm. This modification leads to greatly reduce hardware complexity, make it suitable for integration with the loop filter. Therefore, the loop and post fillers are the same in terms of 8-pixel-related algorithm instead of 10-pixel-related in the post-filter.

[Filtering Mode]

To combine the edge filtering between in-loop and post-loop filters, the present invention modifies the default mod of post filter and applies the loop filter process of “bs=4” into the DC offset mode of post filter. In table 3, the filtering mode can be partitioned into strong and weak mode. The strong filtering mode in the post filter is similar to the loop filter, the present invention applies the loop filter process of “bs=4” instead of the original DC offset mode in MPEG-4 Annex F.3. Further, the present invention modifies the approximated DCT kernel (i.e. [2 −5 5 −2]) into the [2 −4 4 2]. Therefore, a simple shifter can be employed instead of constant multiplier. The present invention also applies the folding scheme to reduce hardware cost. In equation (1) as shown in following, three parallel operations are folded into a single operation within three cycles. All the modification of post filter design can be summarized in Table 3. In FIG. 3, the architecture of weak filtering strength for the detailed descriptions is illustrated.
a3, 0=([2 −5 5 −2]·[p1 p0 q0 q1]T)//8
a3, 1=([2 −5 5 −2]·[p3 p2 p1 p0]T)//8 (1)
a3, 2=([2 −5 5 −2]·[q0 q1 q2 q3]T)//8
[Pixel-in-Pixel-out Edge Filter]

The invention implements a Pixel-in-Pixel-out edge filter to integrate the loop and post filters into unified architecture. From FIG. 3, the incurred MUX is exploited to switch different filtering functions. In the loop filter, the filtering algorithm of H.264/VAC is implied. The modified filtering algorithm of MPEG-4 Annex F.3 us also realized in the unified architecture of loop/post filter. Therefore, the provided loop/post filter is suitable for the implementation of multiple video standards.

[Memory Organization Between Prediction and Filter]

Different memory organization lead to different memory access and processing latency. The input data of de-blocking filter is just the output data of the prediction unit, and plus the residual data. To improve the overall processing throughput, the invention makes the hardware profiling to decide the memory organization among them. Further, two dedicated single port SRAMs are employed in the invention for not only storing the current and neighboring data but also achieving the efficient data access in each 4×4 edge.

[Memory Organization]

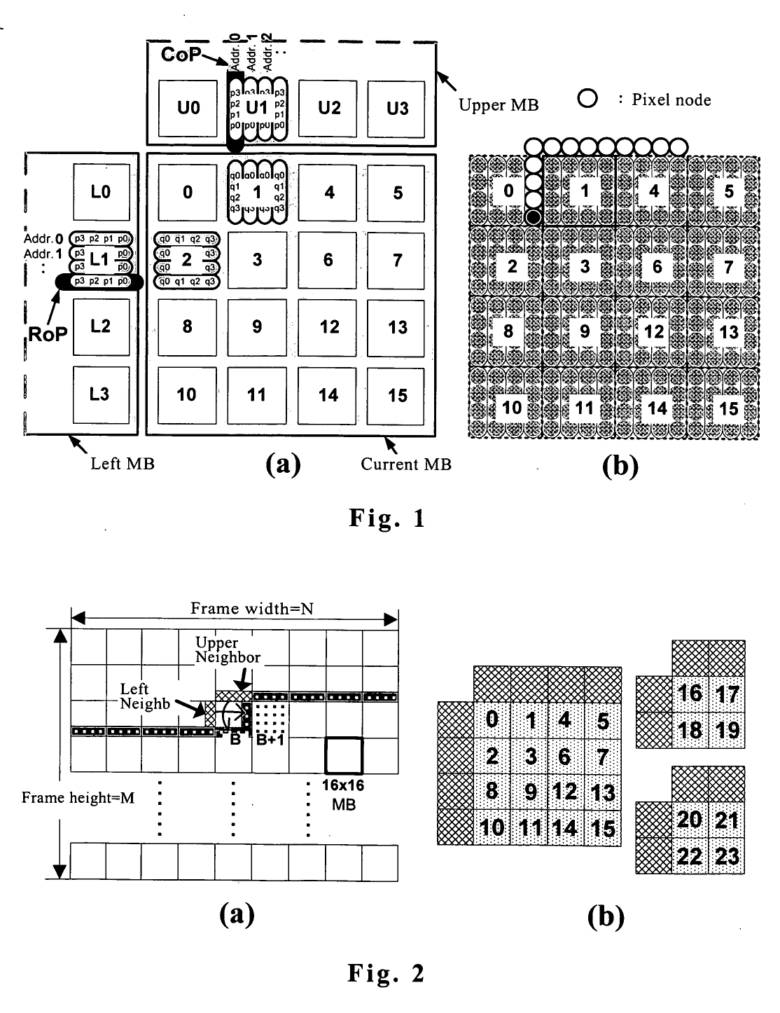

The inventor utilizes one Column-of-Pixel (CoP)_as the data word size in each memory address. In FIG. 1(a), the inventor presents two policies for data arrangement. The Row-of Pixel (RoP) is labeled with the case of L1 and 2 blocks, and the Column-of-Pixel (CoP) is in the case of U1 and 1 blocks. Each row or column of pixel contains four pixels with a total of 32-bit wide. For the de-blocking filter, RoP is a straightforward method to arrange the pixel value in the vertical edge filtering. However, it will induce extra memory access when applying to the horizontal edge filtering. By the same way, this situation is also occurred in the CoP arrangement. Different arrangements of CoP and RoP also affect the number of memory access in the intra prediction and motion compensation (inter prediction) units. In FIG. 1(b), the standard-defined 4×4 sub-block ordering is label in each block. The inventor finds that there are strong dependencies in the horizontal block order. Therefore, the inventor selects CoP data arrangement to reuse the pixel value in the block-boundary with white-cycle region. Further, the inventor lists the hardware profiling in terms of memory access in Table 1. The evaluated cycles with CoP or RoP data arrangement are almost the same in the de-blocking filter unit. The reason is that the filtering process will be performed on not only horizontal edge but also vertical edge. However, there are improvements in the intra prediction unit and motion compensation (inter-prediction) unit when applying the CoP arrangement. Therefore, compared to the RoP data arrangement, the inventor finally selects the CoP data arrangement to reduce the number of memory access.

[Slice and Content Memory]

To facilitate the data access with each block pixel or neighboring pixel, the inventor utilizes two single-port SRAMs named as slice memory and content memory to keep the neighboring pixel and block-content pixel value. The fetching and restoring pixel value is very frequently since de-blocking filter in H.264/AVC is performed on each 4×4 sub-block level. To reduce the pin counts and speed up the filtering process, the internal SRAM module is essential to meet the real-time decoding demand.

The slice memory is used to store the neighboring pixel. It is required to keep them until they have been filtered completely. Further, the address depth is decided by the frame width. In FIG. 2(a), considering the frame size with M×N, each block represents the 16×16 MB, Each MB contains the 16 points, and 4×4 pixels within each point. When the filtering process is performed from the MB index of B to B+1, the pixel data within upper and left neighbor will be updated as the arrows show. The shaded region should be kept when the filtering index is B+1. Therefore, the slice memory is used to keep the pixel value of upper and left neighbor and contains the size of about 2N×32 for the 4:2:0 format.

The content memory is used to store the unfiltered pixel value in luma or chroma block. The data word-length of memory is based on the 32-bit of CoP, and the address depth of content memory is decided by the YUV format (4:4:4, 4:2:2 or 4:2:0). For 4:2:0 format, there are 16 blocks of luma and 8 blocks of chroma should be stored. Therefore, the size of content memory is (16+8)*4×32 in total. Further, the data address is increased as the standard-defined block in ordering of FIG. 2(b). The grid region is stored in the slice memory and the dotted region is stored in the content memory.

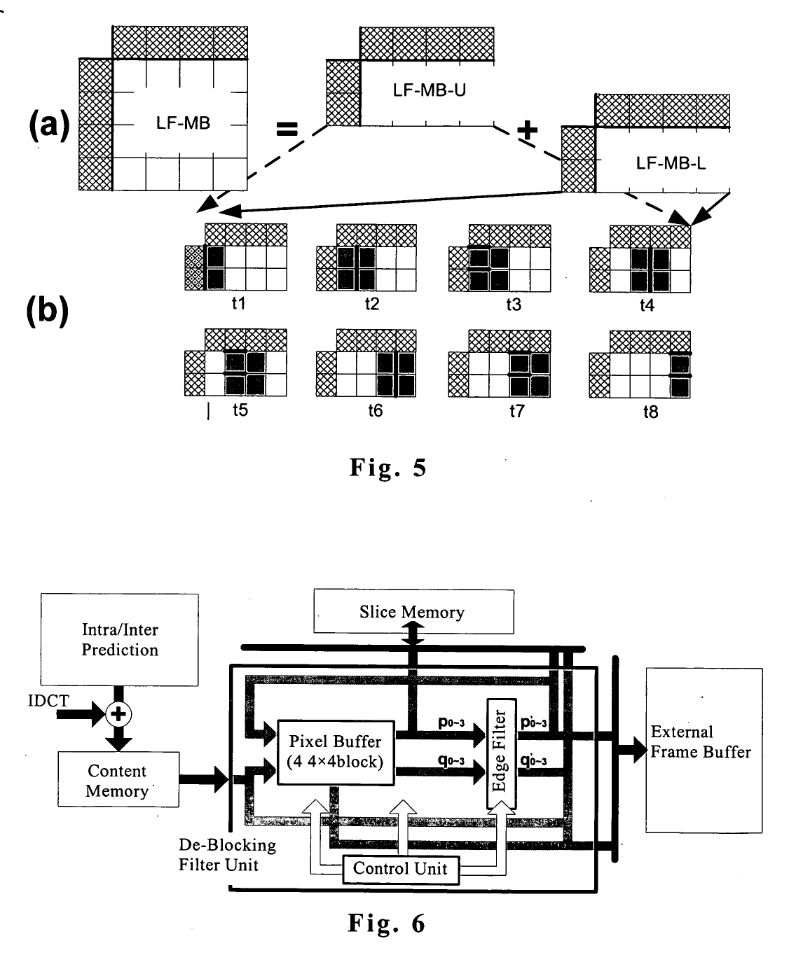

The invention utilizes four 4×4 pixel buffer to keep the temporary data in our hybrid scheduling process. In FIG. 5(a), each MB has been partitioned into two main parts (i.e. Loop Filter-MB-Upper or Lower) to reduce the kept buffer size. Each part is composed of eight time-instances to process the filtering procedure in FIG. 5(b). The grid region represents the neighboring block and the shaded region is the position of kept data buffer with the size of four 4×4 sub-blocks. There is no need to keep the neighboring block as the data buffer in each time instance (except for the initial state t1 since we use the CoP data arrangement) because the neighboring block and current MB are located at different memory module. Both data of them can be accessed at the same time instance and sent to the input of edge filter.

The invention derived the filter ordering of the proposed hybrid scheduling method in FIG. 5(b). Each bold line represents the edge to be filtered in each time instance. The filtered ordering complied with the hybrid scheduling in FIG. 4(a) at each time instance (t1˜t8). By the same way, the proposed scheduling is also performed in the 4×4 sub-block of chroma representation.

The main problem of the de-blocking filter in H.264/AVC is the considerable amount of memory access and processing cycles. To apply the proposed hybrid scheduling into the overall system and enhance the system throughput, the inventor proposes a high-throughput architecture design of de-blocking filter.

[High-Throughput Loop Filter]

[Proposed Hybrid Scheduling]

To reduce the overhead with the reloaded data when switching the filtering edge from horizontal to vertical, the invention provides a hybrid filter scheduling to re-schedule the standard-defined edge. The de-blocking filter in H. 264/AVC is performed in the vertical edge first, and then the horizontal edge. Based on the standard-defined filter ordering, the invention can deduce the filter order on each 4×4 sub-block as FIG. 4(a). In the filter ordering of 4×4 sub-block, left edge is filtered first and lower edge is the last one. The invention provides a novel filter ordering to schedule our filter process on each edge as FIG. 4(b). Each filter order of one block obeys the rules of the left edge first and the lower edge last. Compared to the traditional scheduling, the invention provided a method prevents the re-access for different direction and combine the vertical and horizontal filter at the rule of standard-compliance.

The main problem of the de-blocking filter in H.264/VAC is the considerable amount of memory accesses and processing cycles. To apply the provided hybrid scheduling into the overall system and enhance the system throughput, the inventor proposes a high-throughput architecture design of de-blocking filter.

[Proposed Architecture of Loop/Post Filter]

FIG. 6 shows the proposed design with block diagram and data flow representation according to the invention. In FIG. 6, the inventor selects CoP memory arrangement. The single-port SRAM modules is exploited for such an architecture and stores data of decoded pixels and edge pixels. The external frame buffer is an off-chip memory and size is decided by the frame size and the frame number for the long-term prediction. The shaded-arrows denote the data flow inside the de-blocking filter unit, and the black-arrows denote the data flow outside. The pixel buffer is used to store the intermediate pixel value when applying the provided hybrid scheduling.

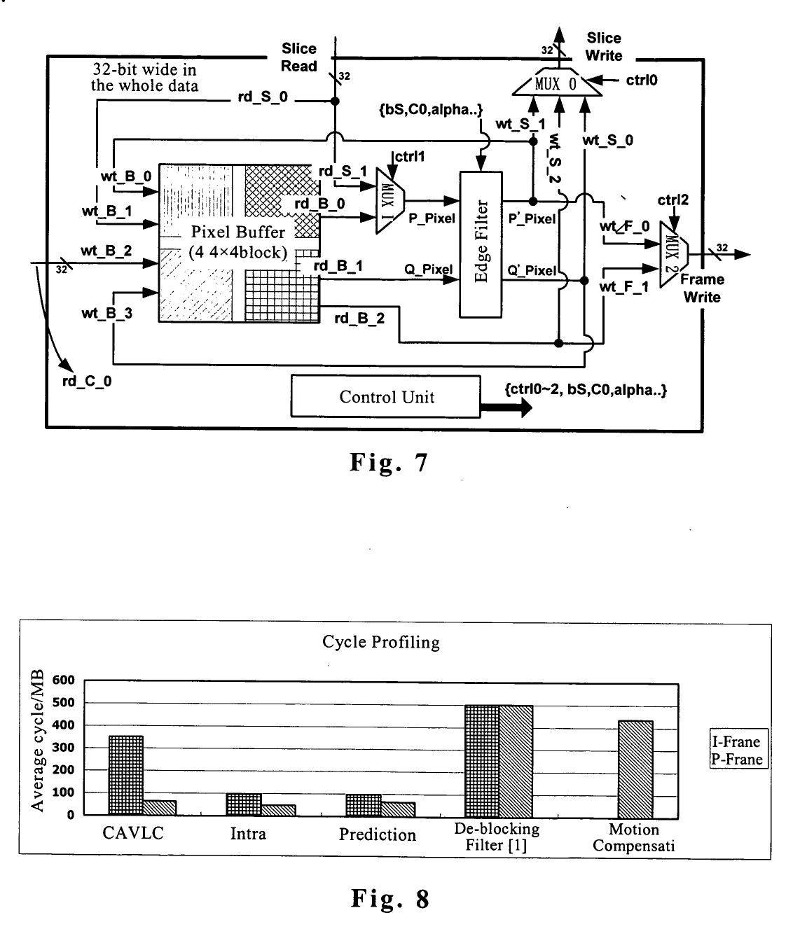

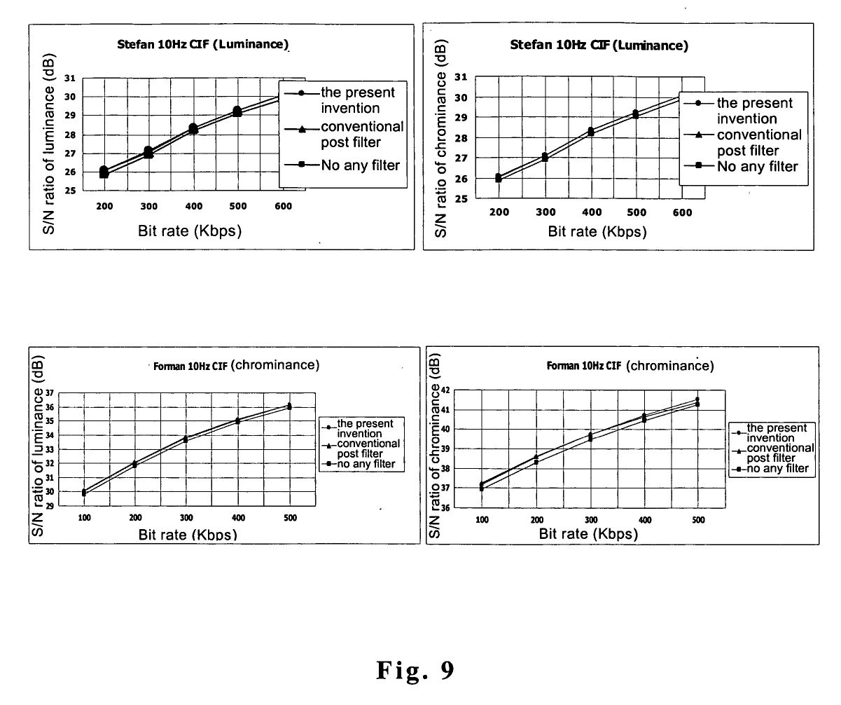

The detailed architecture for the de-blocking filter unit of FIG. 6 has been shown in FIG. 7. All the data signals are 32-bit wide and contain the LoP of memory organization discussed in section 2. There are four input signals {wt_B_O, wt_B_1, wt_B_2, wt_B_3} to write the buffers with 4 blocks. Further, there are three output signals {rd_B_o, rd_B_1, rd_B_2} to read three of them to perform the edge filter, pixel buffer or slice memory. In addition, the write result of the 4 blocks is shown in FIG. 5(b) to achieve the hybrid filtering and avoids the extra access from the filtering of different directions. By the same naming rule, each data flow represents the writing/reading to/from the storage module including slice memory, content memory or frame buffer.

After the behavioral illustration of pixel buffer, the inventor uses one MB with 48 edges as an example to illustrate the other behavior of FIG. 7. The behavior of FIG. 7 can be partitioned into two main parts.

Write Process is a writing mechanism through the signal {wt_S_0˜2, wt_F_0˜1, wt_b_0˜3}.

Read Process is a reading mechanism through the signal {rd_S_0˜1, rd_C_0, rd_B_0˜2}.

For writing to slice memory, wt_S_0 is used to write the filtered data into the slice memory, and it will be activated only on the edge 6,10,14 and 16 (see FIG. 4(b)). For the edge 6, the lower block will become the next neighboring block of LF-MB-L in FIG. 5(b). The same condition is also applied on the edge 10, 14 and 16. Further, the wt_S_1 will be activated on the edge 31, 32,40 and 48. The wt_S_2 is performed to write the dotted block data of FIG. 4(b) into the slice memory. For the writing signal of frame buffer, wt_F_0 is used to write filtered data into the external frame buffer. It will be activated on each filtering of horizontal edge except for the edge of activated signal wt_S_1 and wt_B_0, since wt_F_0, wt_S_1 and wt_B_0 have the same root-signal of P′_Pixel. For the edge of 6 as an example, the upper block of edge 6 is the P′_Pixel of edge filter's output. This block will write to the external frame buffer since it has been filtered completely for all the edges of {1,3,5,6}. The wt_F_1 is performed in the same way except that the input signal comes from the output of pixel buffer.

For the reading process of slice memory, rd_S_O is only activated on the edge of {1,2,17,18,31,33,34,39,41,42,47}. For the edge 1, the rd_S_O is the input of pixel buffer. The inventor needs to keep the pixel value since we apply the CoP arrangement of each data. That's why we keep the left neighboring as the pixel buffer in the t1 of FIG. 5(b). However, for the vertical filtering of edge {,59,13,15,21,25,29,37,45}, it can directly feed through the edge filter by rd_S_1. Finally, compared to the existing approach, the content memory of proposed design is only used for read. There is no need to store the filtered result into the content memory in one direction, and read them in another direction. By our proposed hybrid scheduling, we combine the horizontal and vertical filtering process in one filtering flow. Therefore, we need 4 blocks at most to perform the hybrid filtering.

[Proposed Architecture of De-blocking Filter]

FIG. 6 shows the proposed design with block diagram and a data flow representation. The size and organization of content and slice memory have been presented on above. We choose CoP memory arrangement to improve the pixel data utilization and reduce the memory access in the prediction unit. The external frame buffer is an off-chip memory, and the size is decided by the frame size and the frame number for the long-term prediction. The shaded-arrows denote the data flow inside the de-blocking filter unit, and the black-arrows denote the data flow outside. The pixel buffer is used to store the intermediate pixel value when applying the proposed hybrid scheduling. It contains the four 4×4 pixel values. Moreover, in each time instance, it locates at the position as the shaded regions of FIG. 5(b) shows. The edge filter is a simple parallel in and parallel out process. It exploits the 3, 4 or 5-tap filter to attenuate the blocking artifacts due to the motion compensation or prediction error coding in each block boundary.

Further, according to the invention, both H.264/AVC and MPEG-4 adopt the de-blocking filter to eliminate the blocking artifacts. However, the H.264/AVC adopts the de-blocking filter as an in-loop process and the other standards adopt it as a post-loop process. The detailed features of de-blocking filter are listed in Table 1. To provide the unique architecture for multiple video standards. The invention provides a hybrid scheme to integrate the standardized in-loop filter and the informative post-loop filter. We call it as loop/post de-blocking filter in this literature.

Due to the non-standardization of post-filter it provides high freedom to develop a certain suitable algorithm for the integration with loop-filter. Based on the original algorithm of 4×4 loop-filters, an 8×8 post-filter has been developed. The inventor modifies the filtered ordering and the number of related pixel. Therefore, the modified post-filter can easily be integrated with the 4×4 loop-filter. Simulation results also show that the proposed loop/post filer incurs the penalty of slight PSNR loss (0.02 dB) and extra 11.7% cost compared to the original loop filter.

In FIG. 8, it can be found that the de-blocking filter is the system bottleneck based on the single-port architecture (see FIG. 1). Therefore, a high throughput de-blocking filter is essential to improve the system throughput. In traditional de-blocking filter architecture, vertical edges are filtered first, and then horizontal edges are filtered. Unfiltered data should be fetched in each direction. Therefore, memory accesses are doubled for one 4×4 sub-block or 8×8 block. We modify the processing order of filtered block boundaries without affecting the pre-defined data dependency. Compared to available designs the proposed loop/post filter architecture can save about one-half of processing cycles.

[Simulation Result]

Simulation results are summarized in Table 5. The target technology is 0.18 μm, and the synthesized gate count is 25.2K excluding the adjacent and current MB memory. Two single port SRAM is organized to store the current and adjacent MB data. They contain the size of 96×32 and 64×32 respectively. We modify the post filter algorithm and make a compromise between the integration cost and the performance loss. We use “Foreman” and “Stefan” as our test sequences. In FIG. 6, the performance loss of the modified post filter is only 0.02 dB compared to the traditional post filter. Moreover, the incurred gate count for post filter processing is about 11.7% (i.e. 2.64/2256, see Table 5).

In the loop filter operation of Table 5, the evaluated cycle counts are 159 cycles for cycles for Luma block and 90 cycles for chroma block. Specifically, there are 4×32 cycles to filter each horizontal and vertical edge in one luma MB. Finally, we need 20 cycles to write the filter results and incur 3 cycles due to the data hazard in our filtering process. Totally, we need 159 (i.e. 8+4×32+20+3) cycles to filter horizontal and vertical edge of luma MB. By the same analysis, we need 90 (i.e. 4+4×8+1=45 for each chroma) cycles in chroma block. Therefore, there are 250 cycles with extra 1 cycle for data hazard. After that, the processing cycles of post filter can be obtained through the similar analysis. The numbers of edge are smaller than that of loop filter, but they need 3 cycles for each edge filtering operation. In other word, the post filter needs processing cycles of 305 (i.e. 200+104+1) in each MB.

Finally, the evaluated cycle count per MB is 250 and 305 in the loop and post filter operation. Further, compared with available approaches, the proposed architecture saves about one-half of processing cycles per MB. Originally, the de-blocking filter is a system bottleneck in terms of processing cycles (see FIG. 1). Based on the proposed architecture, we can greatly reduce the processing cycles into 350 cycles/MB (i.e. the processing cycles of CAVLC in I-frame) and improve system throughput (i.e. 350 cycle/MB=9523 MB/frame with 30 fps@100 MHz). Therefore, this processing capability can real-time decode 1080 HD (1+20×1088, i.e. 816 MB/frame) or higher with 4:2:0 format when the working frequency is 100 MHz.

Summing up the foregoing, in new generation of HD-DVD video decoding system, the system should support different standards for MPEG-2, H.264, and WMV-9. Among others, there is no loop filter in the video decoding standard of MPEG-2, however, it can be applicable for post filter. Therefore, the inventor analyzes the differences in between and proposes a dual mode filter configuration capable of integrating the different standards. Further, for the number of frequent filtering and the complicated algorithm of filtering, the present invention employs a hybrid scheduling to merge the edge filtering in any direction in order to reduce the number of memory access. Finally, the overall throughput can be promoted and the demand for physically decoding the high quality picture can also be achieved.

Having thus described several aspects of the invention, it is to be appreciated various modification and equivalent will readily occur to those skilled in the art. Such modification and equivalent are intend to be part of this disclosure, as well as to be within the spirit and scope of the invention.

TABLE 1
# of memory access

| | Intra | Inter | De-blocking |
|---|---|---|---|
| Memory Arrangement | Prediction | Prediction | Filter |
| CoP | 40 | 313 | 151 |
| RoP | 48 | 432 | 151 |
| Improvement | 17% | 28% | 0% |
| (RoP − CoP)/RoP | | | |

TABLE 2

| Cycle Counts | | [1]'s basic | [2] | Proposed |
|---|---|---|---|---|
| Vertical/Horizontal | | Seperated | Seperated | Hybrid |
| Luma | Horizontal | 128 | 104 | 159 |
| | Vertical | 200 | 110 | |
| Chroma | Horizontal | 64 | N/A | 90 |
| | Vertical | 112 | N/A | |

| | | | |
|---|---|---|---|
| Total | 504 | 214 + N/A | 250 |

TABLE 3

| | | Loop Filter_{[3]} | Post Filter_{[4]} | Proposed loop/post |
|---|---|---|---|---|
| Filtered Control | Filtered Edge | 4 × 4 | 8 × 8 | 4 × 4 & 8 × 8 |
| | Filtered Ordering | Vertical first | Horizontal first | Vertical first |
| Mode Decision | Algorithm | Syntax-dependent | 10-Pixel-deperdent | Syntax & modi fired |
| | dependency | | | pixel dependent: |
| | | | | 8-pixel dependent |
| Filtering Mode | Filtered | Bs = 4 | DC offset mode | bs = 4 |
| | Strength(strong) | | | |
| | Filtered | bs < 4 | Default mode | bs < 4 & modi fired |
| | Strength(weak) | | | default mode: [2-4 4-2], |
| | | | | folding scheme |

TABLE 4

| De-blocking Filter | In-loop | Post-loop | |
|---|---|---|---|
| Standardization | Normative | informative | |
| STANDARD | H.264/AVC | MPEG-4(Annex | H.263(Annex |
| | | F.3) | J) |
| Filtered boundary | 4 × 4 Edge | 8 × 8 Edge | 8 × 8 Edge |
| Filtered ordering | Vertical | Horizontal | Horizontal |
| | edge first | edge first | edge first |
| No. of related pel | 8(4-pel | 10(5-pel | 4(2-pel |
| (max) | per side) | per side) | per side) |

TABLE 5

| Items | [1] | [2] | Proposed Loop/Post Filter | |
|---|---|---|---|---|
| Functionally | Loop Filter | Loop Filter | Loop Filter | Post Filter |
| Design | Shift-register | Line-buffer based | Line-buffer based design | |
| Methodology | based design | design | | |
| Kept Data Size | 2 blocks | 4 blocks | 4 blocks | |
| Gate Count | 18.91K (0.25 um) | N/A | 25.2K(=22.56K + 2.64K)(0.18 um) | |
| Working | 100 MHz | N/A | 100 MHz | |
| frequency | | | | |
| Processing | 504 cycles/MB | 214 cycles/luma-MB + N | 250 cycles/MB = 159 | 305 cycles/MB = 200 |
| cycles per MB | | cycles/chroma-MB | cycles/luma-MB + 91 | cycles/luma-MB + 104 |
| | | | cycles/chroma-MB | cycles/chroma-MB |

| | | | |
|---|---|---|---|
| Memory | 2 singe-port SRAM | N/A | 2 singe-port SRAM |
| Requirement | (basic architecture) | | |

What is claimed is:

1. A dual mode hybrid scheduling method, comprising:
(a) using hybrid horizontal and vertical filtering to reduce a demand on memory access without modification of original data correlation for filtering;
(b) in a dual mode architecture, merging different features of filters in the hybrid scheduling for processing; and
(c) using 4 of 4×4 sub-block pixel buffers to implement the hybrid scheduling to achieve an optimum throughput and a minimum hardware loading.

2. A dual mode de-blocking filtering algorithm architecture, comprising at least a loop filter and a post filter, wherein analyzing different filter algorithm architecture and modifying the post filter based on standard-defined loop filter, so that the final overall performance and the hardware cost are a optimum mode.

3. The filtering algorithm architecture according to claim 2, wherein the architecture performs a suitable operation on edge filters to lower hardware loading in the integration.

4. The hybrid scheduling method according to claim 1, wherein the hybrid scheduling can be performed by any type of software, a digital versatile processor, a digital signal processor or a hardware.

5. The filtering algorithm architecture according to claim 2, wherein the hybrid scheduling can be performed by any type of software, a digital versatile processor, a digital signal processor or a hardware.
